(19) United States
(12) Patent Application Publication
(10) Pub. No.: US 2008/0281989 A1
(43) Pub. Date: Nov. 13, 2008

(54) MEDICAL INSTRUMENT HAVING A SEPARATE TRANSMITTER FOR CONTROLLING MEDICAL TREATMENT SOFTWARE

(76) Inventors: Stefan Hager, Munich (DE); Alexander Urban, Markt Schwaben (DE)

Correspondence Address: DON W. BULSON (BRAI), RENNER, OTTO, BOISSELLE & SKLAR, LLP, 1621 EUCLID AVENUE - 19TH FLOOR, CLEVELAND, OH, 44115, US

(21) Appl. No.: 12/113,650

(22) Filed: May 1, 2008

Related U.S. Application Data
(60) Provisional application No. 60/939,213, filed on May 21, 2007.

(30) Foreign Application Priority Data
May 9, 2007 (EP) 07009316

(51) Int. Cl. G06F 3/00

(52) U.S. Cl. 710/1

(57) ABSTRACT

The patent discloses a medical instrument having a control device for controlling medical treatment software, wherein the control device includes a transmitter for transmitting software control signals and at least one control for activating the transmitter. The transmitter may be provided as a separate transmitter unit, and the instrument may include a closable interior receptacle, wherein the transmitter unit can be inserted into and removed from the interior receptacle.

### RELATED APPLICATION DATA

This application claims priority of U.S. Provisional Application No. 60/939,213 filed on May 21, 2007, and EP 07009316 filed on May 9, 2007, which are incorporated herein by reference in their entirety.

### FIELD OF THE INVENTION

The invention relates to a medical instrument including a control device for controlling medical treatment software. It also relates to a system of such instruments.

### BACKGROUND OF THE INVENTION

In computer-assisted surgery, a navigation and/or tracking system in an operating theater provides a surgeon with different image outputs. These image outputs represent patient data sets or at least parts of them. For example, the outputs may depict three-dimensional or sectional representations of parts of the patient's body. The patient data sets can be produced either by imaging methods such as CT or MR tomography, x-ray, ultrasound or fluoroscopy, or by image-free methods such as tapping the surface of a bone using a registered pointing instrument, or by laser scanning. To provide the surgeon with visual guidance, it is also possible to display instruments or treatment devices in their positional relationship to the patient data.

Depending on the progress of the treatment, it is often desirable to display a specific part or feature of the software on the screen. That is, the physician may want to call up the software component that includes the functions presently required for the current treatment step. The software could be said to consist of different “pages,” that are exchanged during the course of the treatment. It is often desirable to select particular software pages during the treatment, and this selection is often performed using an input apparatus such as a mouse, keyboard, or touch-sensitive screen. Foot switches, virtual keyboards, and speech control are also known. It can be very distracting, however, for surgeons to attend to switching over the software in addition to their operating activities.

Instruments including touch-sensitive tips have been developed that provide a signal transmitter in or on the instrument, such that a signal is emitted when the patient's “surface” is touched. See for example, EP 1 302 172 A1. The use of such instruments, however, has been limited to patient registration purposes.

WO 01/54558 A2 discloses a surgical system that uses a pointer that includes software control buttons. The pointer shown in this disclosure actively emits navigation tracking impulses via LEDs, such that it can be localized and positionally tracked. The control device for the software is fixedly integrated with the pointer, making sterilization difficult. Additionally, the tips of the instruments are exchangeable, but always require instrument recalibration.

### SUMMARY OF THE INVENTION

A medical instrument in accordance with the invention has a control device for controlling medical treatment software, wherein the control device includes a transmitter for transmitting software control signals and at least one control for activating the transmitter. The transmitter may be provided as a separate transmitter unit, and the instrument may include a closable interior receptacle, wherein the transmitter unit can be inserted into and removed from the interior receptacle.

In other words, the medical instrument includes a transmitter unit that is exchangeable and/or can be provided separately from the instrument and that can be accommodated in the instrument body. A separate, insertable and removable transmitter unit affords many advantages, one of which is that the transmitter unit can be removed from the instrument for sterilization. By removing the transmitter, problems with the sterilization of transmitter parts or energy supplies are removed. Providing the interior receptacle for the transmitter unit does not alter the exterior shape of the instrument, and the instrument can be used normally, with the additional advantage that it can be used to control the software. A single transmitter unit can be used for a plurality of instruments that have been pre-calibrated. Precalibration means that the position of the functional part of the instrument (for example, the tip) relative to the navigation reference marker is known and/or is stored in the navigation system.

In one example of the instrument, the instrument includes a quick-release cover (for example, a hinged cover, a cap cover or a sliding cover), for closing the interior receptacle. Such quick-release covers provide ease of handling and the transmitter unit can be quickly removed and/or inserted.

The cover for the interior receptacle can be sealed, and in one example, the transmitter unit is a wireless transmitter unit. In the latter case, it is advantageous if an electrical energy supply (for example, a battery) for the transmitter unit can be inserted and removed with the transmitter unit. The battery also can be provided together with the transmitter unit or arranged on or in it. The instrument can operate wirelessly, and the transmitter unit, which may be difficult to sterilize, is situated in the interior of the instrument, and therefore no longer represents a sterility problem.

In accordance with another example, an activating device is arranged on the transmitter unit, wherein the activating device can be inserted and removed with the transmitter unit. The activating device can include at least one confirming switch and/or a selecting device for different software features, wherein the selecting device is integrated with the confirming switch or is provided separately from it. Such a confirming switch could correspond to the “enter” key on a keyboard or to a button on a mouse. Examples of activating devices that can be used with the instrument are a push button, a scroll wheel (with or without a push switch), and a joystick (with or without a rocker switch). This list is not exhaustive and the device in accordance with the invention also can use other activating or confirming devices.

In accordance with another example, apertures may be provided on the casing of the instrument (also in the cover for the interior receptacle), for activating devices that are arranged on the transmitter unit and protrude outwards from the instrument casing. Coverings, such as flexible protective coverings, may be arranged over the apertures on the instrument casing and accommodate the activating devices, so as to maintain the seal on the interior receptacle.

In accordance with another example, the medical instrument may be constructed such that the activating device includes a first part that is arranged on the instrument casing (and seals the casing and/or the cover tight against the outside) and a second part that is arranged on the transmitter unit. The second part responds to the activation of the first part. For example, the first part seals the instrument so as to create a sterile environment on an inner portion of the instrument, wherein the first part can serve as an activating device. Because the second part on the transmitter unit responds to the activation of the first part (for example, by moving when the first part is moved), pressing the first part is sufficient to activate the pair.

In accordance with another example, the medical instrument can be provided with reflective markers and can be localized and positionally tracked using a medical navigation and tracking system.

In accordance with another example, a pointing instrument (or pointer) can be tracked by a camera system (a tracking system) using reference markers that are attached to the pointer. This enables the position of the pointer tip to be depicted in data sets of the patient. The software that processes the patient data can be activated using the activating device in the pointer handle, such that the software performs specific steps that previously had to be selected in a more inconvenient manner (for example, using a touch screen monitor of the navigation system). The data may be transmitted wirelessly, and the device may be powered by an energy source arranged in the pointer such that cables do not have to be provided with the pointer. Such a pointer can transmit information concerning the desired software step. The pointer also can combine different selection steps and simplify the use of the software (for example, in steps such as setting a trajectory or acquiring points, one may simply activate a button on the pointer). The navigation system (and/or the system on which the medical treatment software is running) can have a ready-to-receive receiver that can receive the signals from the transmitter unit.

In accordance with another aspect of the invention, an instrument system includes a plurality of instruments such as have been described above. These instruments include interior receptacles that can accommodate the same or similar transmitter units, and the system uses at least one separate transmitter unit. The same transmitter unit can be used in different pre-calibrated instruments, thus providing the surgeon with the freedom to select the instrument that he is using in the respective stage of the operation.

### BRIEF DESCRIPTION OF THE DRAWINGS

The forgoing and other features of the invention are hereinafter discussed with reference to the figures.

FIG. 1 illustrates an exemplary medical instrument in accordance with the invention, with the interior receptacle swung open and the transmitter unit removed.

FIGS. 2 and 3illustrate different stages of inserting the transmitter unit into the exemplary configuration of FIG. 1.

FIG. 4 illustrates an exemplary configuration of an instrument in accordance with the invention, with the transmitter unit inserted and the cover closed.

### DETAILED DESCRIPTION

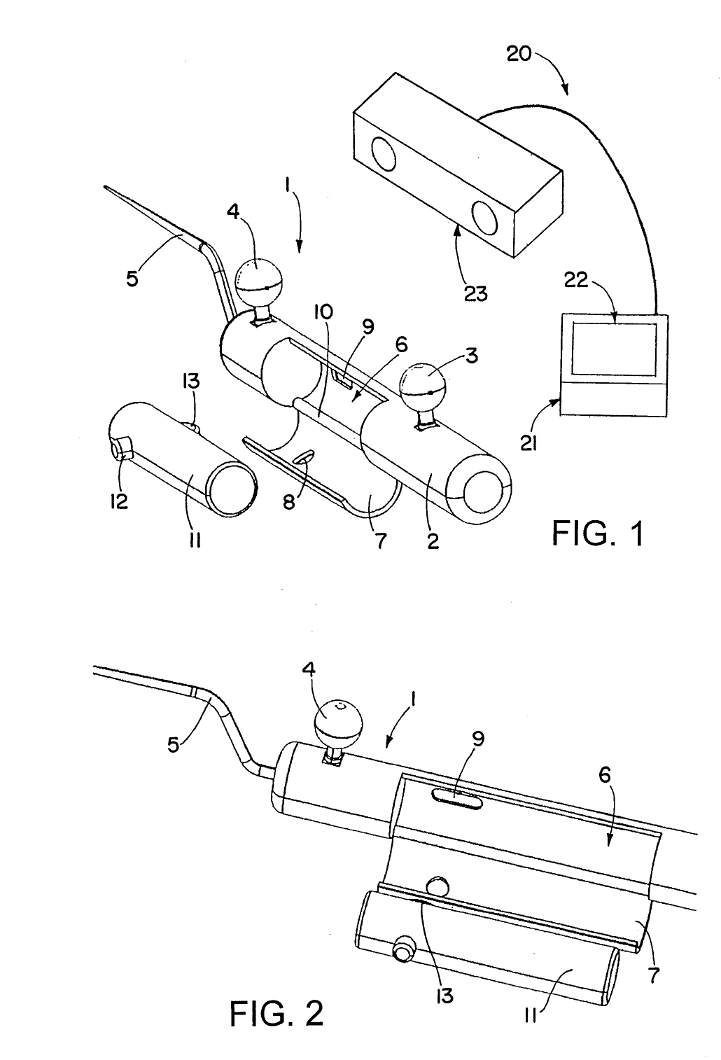

FIG. 1 illustrates in detail the individual parts of an exemplary instrument 1, e.g., a pointer. The pointer 1 has a handle 2 that forms a casing. Navigation reference markers 3 and 4 are arranged on the handle 2 and in this example are embodied as reflective markers and/or spherical reflectors. The instrument 1 has a pointer tip 5.

In its central region, the instrument or the handle 2 comprises an interior receptacle or cavity 6, in this example, a cylindrical hollow space. A cover 7 can be pivoted at a hinge 10 to seal said cavity. The cover 7 and the cavity 6 comprise openings 8 and 9 that will be discussed in more detail below.

Together with the instrument, FIG. 1 also shows a transmitter unit 11 that is also cylindrically shaped and fits into the interior receptacle 6. An activating device (in this example, a push button 12 and a scroll wheel 13) can rest in the aperture holes 8 and 9. The push button 12 and the scroll wheel 13 protrude slightly from the casing formed by the handle 2 and cover 7. The transmitter unit 11, in which an energy supply (for example, a power pack, battery or piezoelectric system) is integrated, is a wireless transmitter unit for transmitting communications signals. Transmitter 11 transmits, for example, radio signals to a medical navigation system 20 that may include a computer 21 that includes controllable support software for controlling, for example, a navigation screen 22. The same or similar navigation system 20 may be used to localize and positionally track the instrument 1 with the aid of a medical tracking system 23, via the reflective markers 3 and 4.

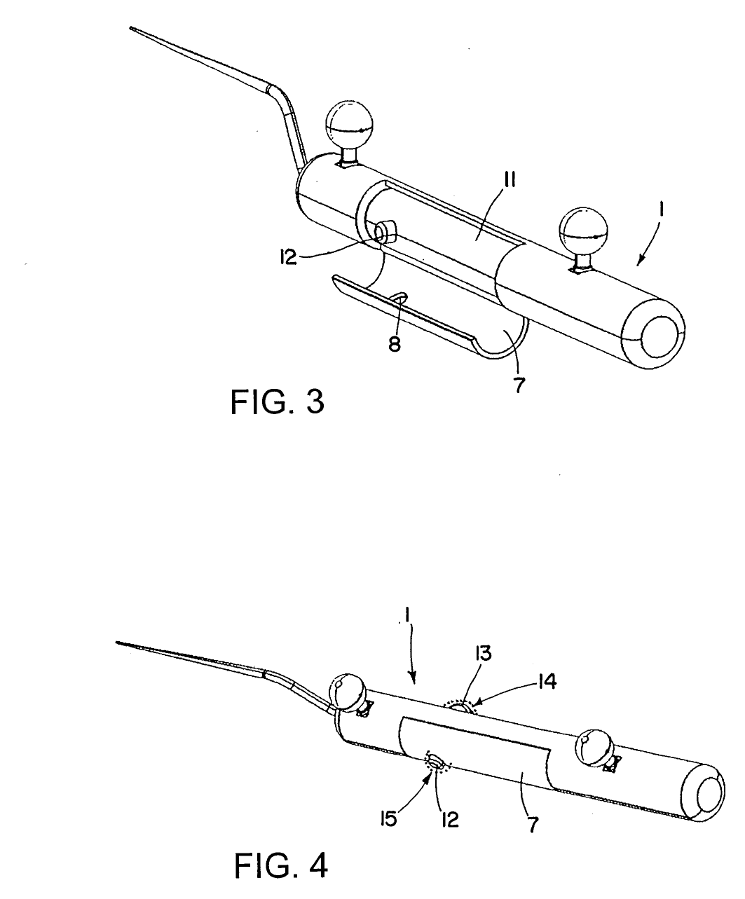

FIGS. 2 and 3 illustrate how the transmitter unit 11 can be inserted into the interior receptacle 6 of the instrument 1, wherein the transmitter unit 11 is initially orientated such that the scroll wheel 13 is orientated towards the opening 9 (FIG. 2). The transmitter unit 11 can then be inserted, such that the situation in FIG. 3 is reached, in which the transmitter unit 11 is lying in the interior receptacle 6. The push button 12 (the confirming or enter button) then lies orientated in such a way that it passes through the opening 8 when the cover 7 is closed.

FIG. 4 illustrates the surgical instrument 1 fitted with the transmitter unit 11, wherein the cover 7 is closed and the activating device (the push button 12 and the scroll wheel 13) protrude slightly from the surface of the instrument through their respective aperture holes, such that they can be activated. Broken lines 14, 15 are shown in FIG. 4 over the button 8 and the scroll wheel 13 that are intended to represent the sterile exterior casing seal. The devices 14, 15 can be flexible protective coverings that are provided if, for example, the button 12 is fixedly attached to the transmitter unit 11. Due to the covering 15, the exterior of the instrument casing remains sterile. The coverings can be flexible enough that the scroll wheel 13 can still be pressed in one direction (for example, against a spring tension) to trigger a scrolling procedure. The dot-dash representation of the coverings can also symbolically indicate an activating device that guarantees a tight casing seal or that only forms a first part of the activating device. The second part can be a tapping sensor on the transmitter unit 11, that engages with the activating device situated on the casing or responds to being pressed.

The instrument 1 can be used as a registration pointer. For this purpose, the registration page of the software may be selected using the scroll wheel 13, and the tip 5 of the instrument 1 is moved to a registration point on the patient. The push button 8 may be used to confirm that the registration point has been reached. Another example is that of selecting a page for setting a treatment trajectory using the scroll wheel 13, orientating the pointer 1 in the direction of the trajectory, and confirming the direction using the push button 8.

If a number of instruments are fitted with interior receptacles that correspond to each other in their dimensions, the transmitter unit 11 can be used together with a plurality of different instruments that are pre-calibrated for navigation.

Although the invention has been shown and described with respect to a certain preferred embodiment or embodiments, it is obvious that equivalent alterations and modifications will occur to others skilled in the art upon the reading and understanding of this specification and the annexed Figures. In particular regard to the various functions performed by the above described elements (components, assemblies, devices, software, computer programs, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A medical instrument for controlling medical treatment software executed by a computer, comprising:
an instrument body forming a closable cavity;
a cover for closing the cavity;
a transmitter removably insertable in said cavity, said transmitter operative to communicate with said computer; and
an activating device for activating the transmitter.

2. The medical instrument according to claim 1, wherein the cover comprises a hinged cover, a cap cover or a sliding cover.

3. The medical instrument according to claim 1, wherein the cover seals said cavity from the external environment.

4. The medical instrument according to claim 3, wherein the cover includes a sealing member to maintain a sterile environment on the exterior of the cavity.

5. The medical instrument according claim 1, wherein the transmitter is a wireless transmitter.

6. The medical instrument according to claim 1, further comprising an electrical energy supply for powering the transmitter, said energy supply removably insertable with the transmitter.

7. The medical instrument according to claim 1, wherein the activating device is arranged on the transmitter and is removably insertable with the transmitter.

8. The medical instrument according to claim 1, wherein the activating device and transmitter cooperate to transmit a plurality of different signals, wherein each signal of the plurality of signals corresponds to a particular operation of the medical treatment software.

9. The medical instrument according to claim 1, wherein the activating device comprises a confirming switch.

10. The medical instrument according to claim 1, wherein the activating device comprises a selecting device.

11. The medical instrument according to claim 10, wherein the selecting device is a scroll wheel.

12. The medical instrument according to claim 1, wherein the activating device comprises at least one of:
a push button;
a scroll wheel, specifically with a push switch;
a joystick, specifically with a push switch; or
a rocker switch.

13. The medical instrument according to claim 1, further comprising:
at least one opening in the body or cover;
wherein when the transmitter and activating device are inserted into the closeable cavity, the activating device extends through the opening.

14. The medical instrument according to claim 13, further comprising: at least one flexible protective covering arranged over the at least one opening, wherein the at least one flexible protective covering operates to seal the closeable cavity from the external environment.

15. The medical instrument according to claim 1, wherein the activating device comprises a first part that is arranged on the body and/or the cover, and seals the body and/or the cover from the outside environment, and a second part that is arranged on the transmitter and responds to the activation of the first part.

16. The medical instrument according to claim 1, further comprising reflective markers arranged on the instrument, said markers trackable by a medical tracking system.

17. A medical instrument system for controlling medical treatment software, comprising:
a plurality of instruments, comprising:
an instrument body forming a closable cavity;
a cover for closing the cavity;
a transmitter removably insertable in said cavity, said transmitter operative to communicate with said computer; and
an activating device for activating the transmitter.;
wherein one instrument's closeable cavity can accommodate another instrument's transmitter.

18. A medical instrument system according to claim 17, further comprising:
a medical tracking system and
wherein said plurality of instruments further comprise markers arranged on each instrument, said markers trackable by the medical tracking system.
